(19) United States
(12) Patent Application Publication
(10) Pub. No.: US 2021/0247497 A1
(43) Pub. Date: Aug. 12, 2021

(54) AN OPTICAL BEAM DIRECTOR

(71) Applicant: Baraja Pty Ltd, North Ryde (AU)

(72) Inventors: Ran LI, Kellyville (AU); Rebecca LODIN, Sydney (AU); Tiago ORTEGA, Sydney (AU); Andrea TABACCHINI, Manly (AU)

(21) Appl. No.: 15/734,728

(22) PCT Filed: Jun. 6, 2019
(86) PCT No.: PCT/AU2019/050583

§ 371 Date: Dec. 3, 2020

(30) Foreign Application Priority Data
Jun. 7, 2018 (AU) 2018902053

(51) Int. Cl. G01S 7/481; G02B 26/08; G01S 7/497; G02B 27/10; G01S 17/894

(52) U.S. Cl. CPC G01S 7/4817; G02B 26/0808; G01S 17/894; G02B 27/1086; G02B 26/0833; G01S 7/497

(57) ABSTRACT

Disclosed herein is a system and method for facilitating estimation of a spatial profile of an environment based on a light detection and ranging (LiDAR) based technique. In one arrangement, the present disclosure facilitates spatial profile estimation based on directing light over one dimension, such as along the vertical direction. In another arrangement, by further directing the one-dimensionally directed light in another dimension, such as along the horizontal direction, the present disclosure facilitates spatial profile estimation based on directing light in two dimensions.

### RELATED APPLICATIONS

The present application is related to and claims priority from Australian patent application 2018902053, filed 7 Jun. 2018, the entire content of which is incorporated herein by reference.

### FIELD

The present disclosure generally relates to a system for directing light into multiple directions. More particularly, the present disclosure relates to facilitating control of the direction of the light based on its wavelength.

### BACKGROUND

Optical beam direction has several uses, including but not limited to LiDAR (light detection and ranging) applications, in which light is sent into an environment for mapping purposes. In two or three-dimensional mapping, one of the dimensions relates to the range of a point from the origin of the optical beam, whereas the other one or two dimensions relate to a one or two-dimensional space (e.g. in Cartesian (x, y) or polar (r, theta) coordinates) in which the optical beam is steered across.

For example international patent publication WO 2017/054036 A1 describes a system including a light source that provides outgoing light having at least one time-varying attribute at selected wavelength channels. A beam director spatially directs the outgoing light into one of multiple directions corresponding to the selected wavelength channel. Reflected light is received at a light receiver and a processing unit performs estimation of the spatial profile of the environment based on the detected light.

### SUMMARY

According to a first aspect of the present disclosure there is provided an optical system for directing light into multiple directions, the system including:
a diffractive assembly to receive light including a selected one or more of multiple wavelength channels, the diffractive element configured to diffract the received light into multiple diffraction orders, two of the multiple diffraction orders being angularly separated by an inter-order angular separation;
a dispersive assembly arranged to receive the diffracted light and increase the inter-order angular separation between the two of the multiple diffraction orders, at least one of the two of the multiple diffraction orders exhibiting an intra-order angular separation of the multiple wavelength channels; and
a light-suppressing assembly configured to suppress the light of one of the two diffraction orders, the light of the other of the two diffraction orders being directed at one or more of multiple directions based on the selected one or more of the multiple wavelength channels.

The two of the multiple diffraction orders may be the m=0 order and the m=−1 order. The m=0 order may be suppressed.

The light-suppressing assembly may include an angle-dependent spectral filter to favour the light of the other of the two diffraction orders. The angle-dependent spectral filter may be a long-edge-pass filter.

The light-suppressing assembly may include an optical absorber positioned to absorb the suppressed light.

The multiple directions may be associated with a first dimension, and the light may be further directed over a second dimension orthogonal to the first dimension by mechanical adjustment of the diffractive assembly.

The dispersive assembly may be further arranged to improve rectangularity of a field of view formed by the first dimension and the second dimension.

The dispersive assembly may be further arranged to reduce unevenness in the distribution of the multiple angles over evenly distributed wavelength channels.

The diffractive assembly may be a transmission diffraction grating and arranged to receive light at a non-normal angle of incidence to reduce back reflection to a light source and/or a light receiver. The non-normal angle of incidence may include contribution formed by angularly adjusting the transmission diffraction grating about an axis parallel to lines of the diffraction grating.

The optical system may further include a retroreflector assembly to retro-reflect light originating from a light source towards the diffractive assembly. The retroreflector assembly and the diffractive assembly may be configured in cooperation to facilitate an S-shaped optical path of the light.

The diffractive assembly may include one or multiple diffractive elements, and the dispersive assembly may include one or multiple dispersive elements interspersing with the one or more multiple diffractive elements.

According to a second aspect of the present disclosure there is provided a method for directing light into multiple directions, the method including:
receiving and diffracting light including a selected one or more of multiple wavelength channels into multiple diffraction orders, two of the multiple diffraction orders being angularly separated by an inter-order angular separation;
increasing the inter-order angular separation between the two of the multiple diffraction orders, at least one of the two of the multiple diffraction orders exhibiting an intra-order angular separation of the multiple wavelength channels;
suppressing the light of one of the two diffraction orders; and
directing the light of the other of the two diffraction orders at one or more of multiple directions based on the selected one or more of the multiple wavelength channels.

According to a third aspect of the present disclosure there is provided an optical system for directing light into multiple directions, the system including:
beam expansion optics to receive light comprising an expanding beam and forming therefrom a substantially collimated beam, the beam expansion optics including a reflector assembly directing the expanding beam along a first folded optical path;
diffractive and dispersive optics including a combination of a plurality of diffractive elements and at least one dispersive element configured to diffract light based on wavelength and direct a portion of the received light along a second folded optical path to a direction, the direction for a first wavelength of the received light different to a direction for a second wavelength of the received light.

The reflector assembly may comprise two reflectors in a fixed orientation relative to each other.

The first folded optical path may comprise a fold of about 180 degrees, for example between 160 and 200 degrees. The second folded optical path may comprise a fold of about 180 degrees or a fold of about 270 degrees, for example between 160 and 290 degrees. In one combination, the first and second folded optical paths may form a substantially S-shaped path.

The combination of a plurality of diffractive elements and at least one dispersive element may consist of two diffractive elements and two dispersive elements.

To effect additional light direction control, at least one of the diffractive elements, for example one of the two diffractive elements, may be mechanically adjustable in orientation.

According to a fourth aspect of the present disclosure there is provided a spatial profiling system including the optical system of the first and/or third aspects.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 illustrates an arrangement of a spatial profiling system.

FIG. 2 illustrates an example of a light source used in the spatial profiling system of FIG. 1.

FIG. 3A illustrates a more detailed example of the spatial profiling system in FIG. 1.

FIG. 3B illustrates an example of beam expansion optics in FIG. 3A.

FIG. 4A illustrates a diffractive element illuminated with normally incident light of multiple wavelength channels diffracted into multiple diffraction orders.

FIG. 4B illustrates another diffractive element illuminated with non-normally incident light of a single wavelength channel diffracted into angularly separated diffraction orders.

FIG. 4C illustrates an example of a wavelength-steering element.

FIG. 4D illustrates a first example of a wavelength-steering element receiving and directing light at different wavelength channels.

FIG. 4E illustrates a second example of a wavelength-steering element receiving and directing light at different wavelength channels.

FIG. 4F illustrates third example of a wavelength-steering element receiving and directing light at different wavelength channels.

FIG. 4G illustrates a combination of beam expansion optics (e.g. of FIG. 3B) and a wavelength-steering element (e.g. of FIG. 4F).

FIG. 4H illustrates an example of the transmissivity of an angle-dependent filter.

FIG. 4I illustrates examples of wavelength-steering elements receiving and directing light at different wavelength channels for simulation demonstrations of reduced “bowing” effect.

FIG. 5 illustrates an angular placement of a diffractive element in a wavelength-steering element.

FIG. 6 illustrates a flow diagram of a method for directing light into multiple directions.

### DETAILED DESCRIPTION OF EMBODIMENTS

Described is a system for directing light into multiple directions, suited to light detection and ranging (LiDAR) applications to generate a two or three-dimensional image of a surrounding environment. “Light” hereinafter includes electromagnetic radiation having optical frequencies, including far-infrared radiation, infrared radiation, visible radiation and ultraviolet radiation. In general, LiDAR involves transmitting light into the environment and subsequently detecting the light reflected by the environment. By determining the time it takes for the light to make a round trip to and from, and hence the distance of, reflecting surfaces within a field of view, an estimation of the spatial profile of the environment may be formed. In one arrangement, the present disclosure facilitates spatial profile estimation based on directing light over one dimension, such as along the vertical direction. In another arrangement, by further directing the one-dimensionally directed light in another dimension, such as along the horizontal direction, the present disclosure facilitates spatial profile estimation based on directing light in two dimensions.

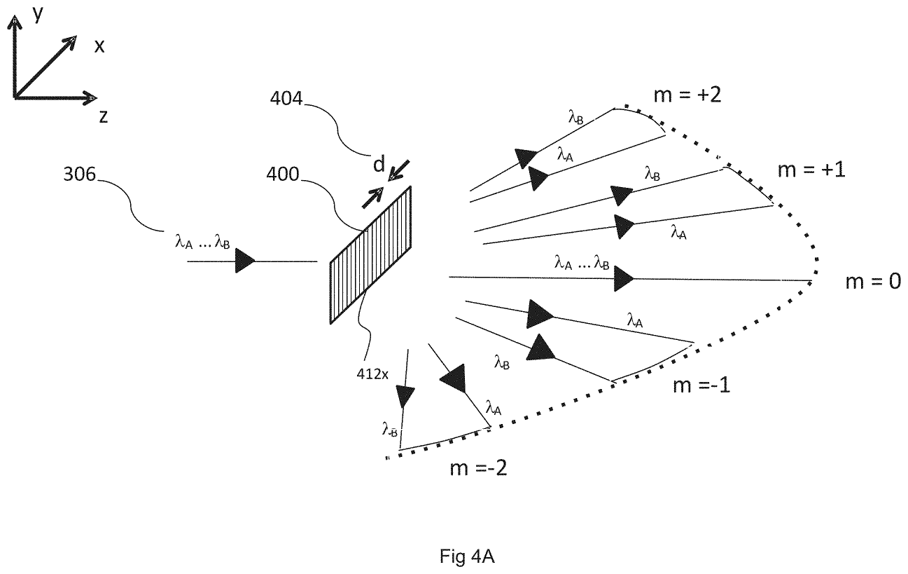

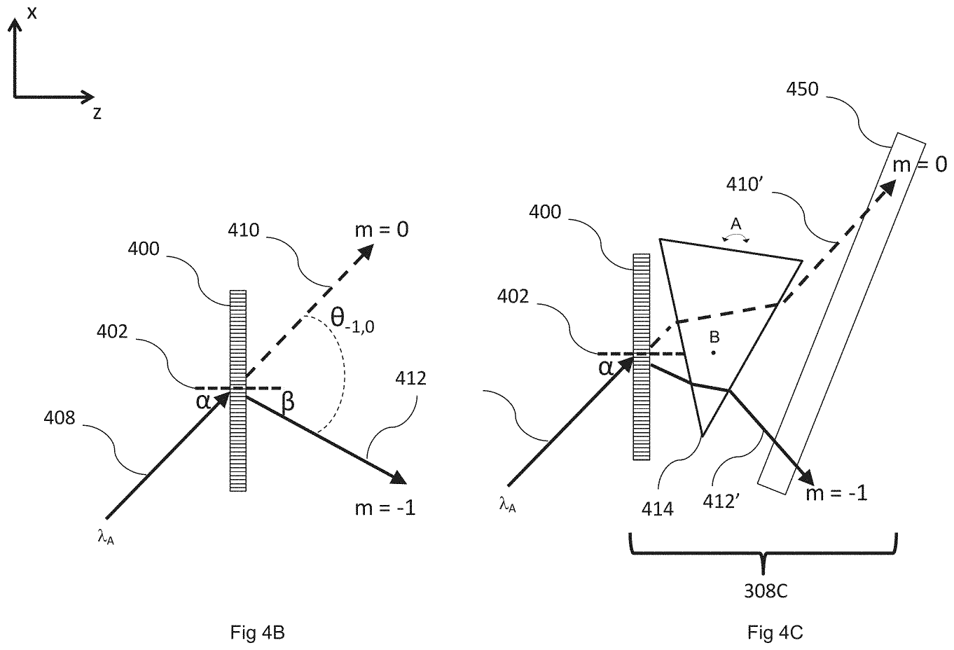

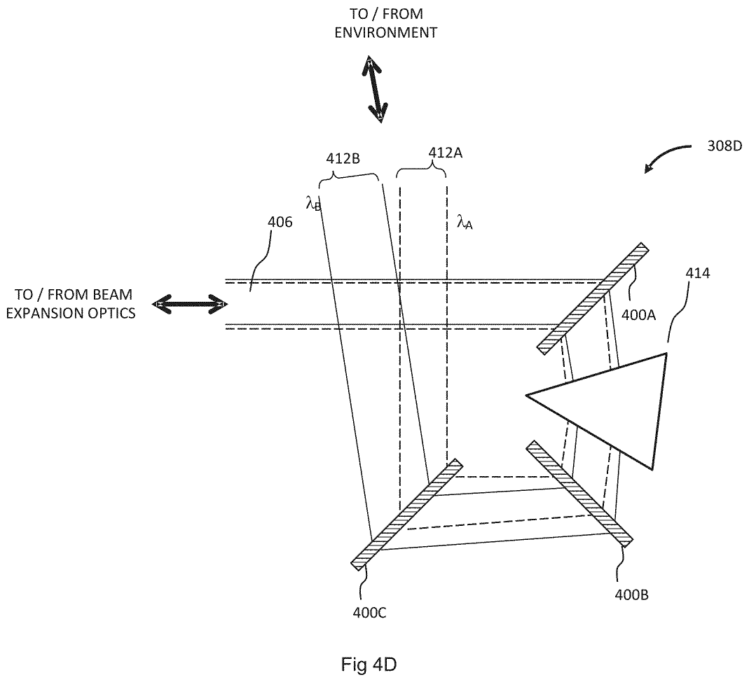

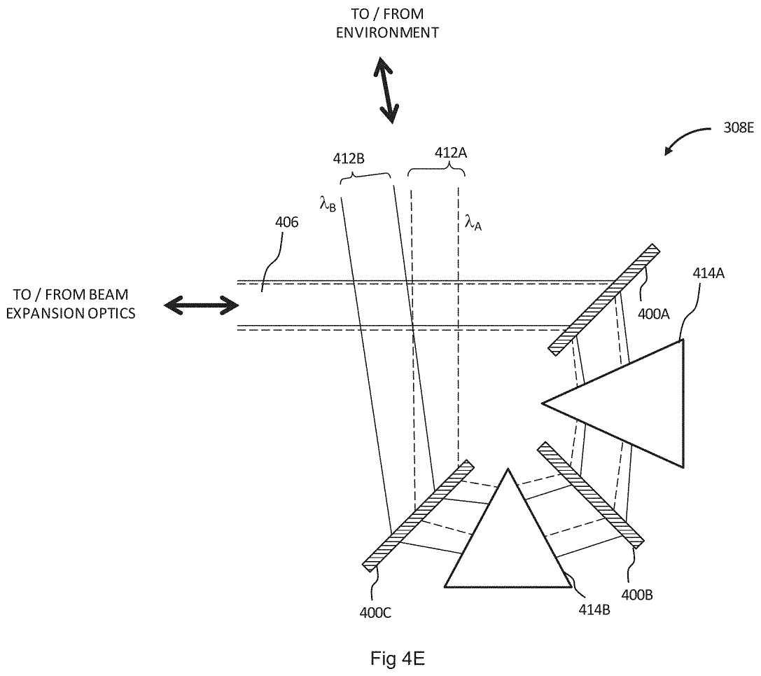

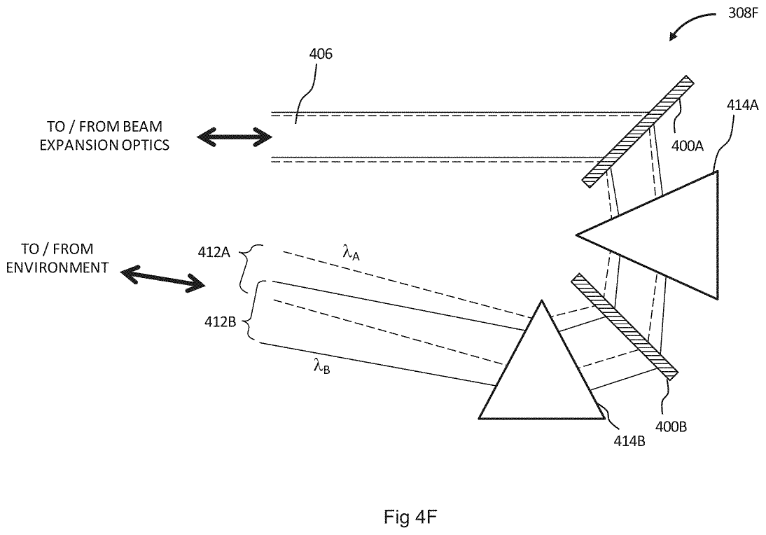

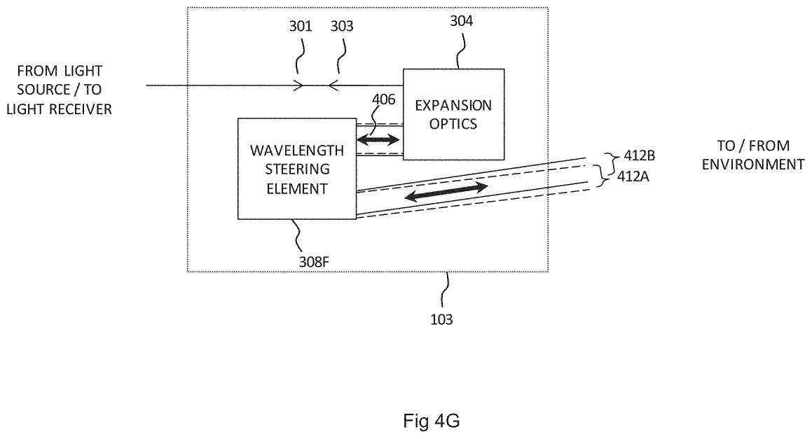

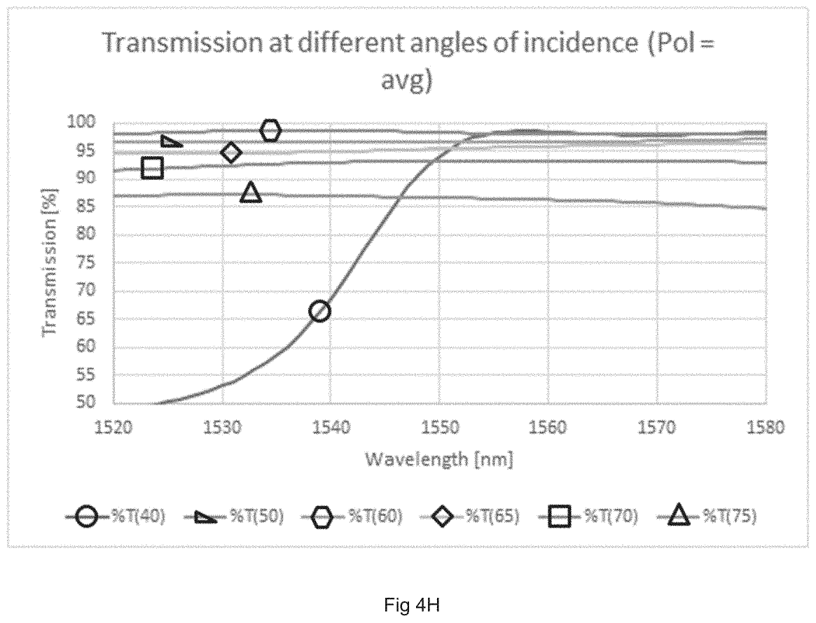

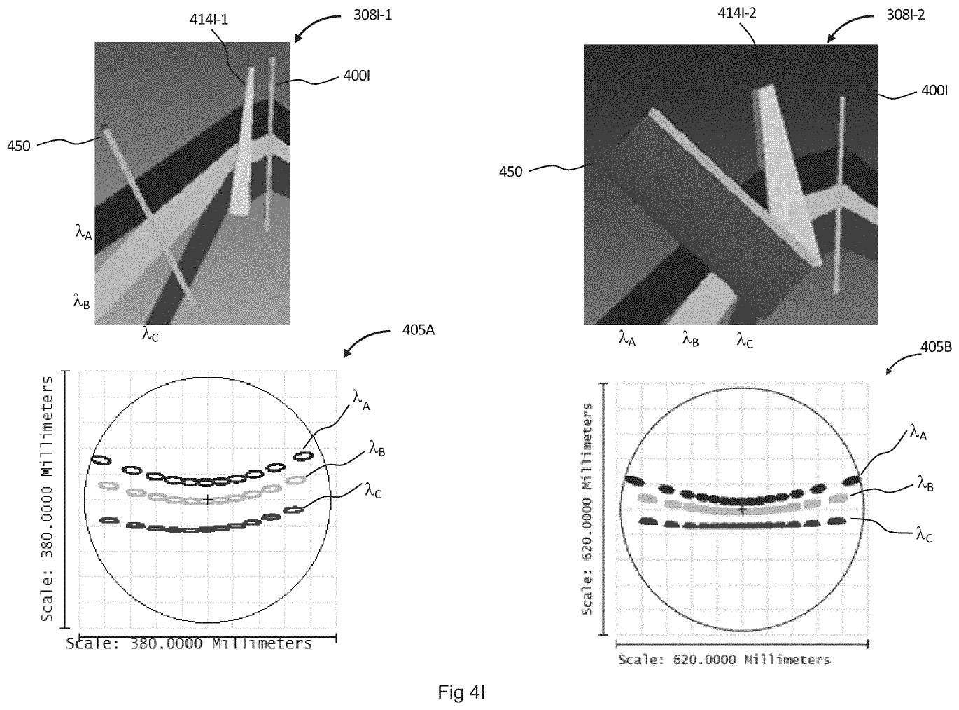

The described system involves receiving light of controllable wavelength, such as that emitted from a wavelength-tunable laser, to control the direction of the light—a class of techniques hereinafter referred to as “wavelength-steering”. A diffractive element, such as a diffraction grating or a periodic structure, is an example of an optical element capable of wavelength-steering. Referring to FIGS. 4A and 4B, a diffraction grating 400 exhibits angular dispersion governed by:

mλ/d=sin(α)+sin(β) (Eq. 1)

where α is the incident angle relative to the grating normal 402, β is the diffraction angle relative to the grating normal 402, d is the grating period 404, λ is the wavelength of the light, and m is an integer known as the diffraction order. Each wavelength channel is centred at a centre wavelength (λ_{A} . . . λ_{B}) and occupies a relatively small spectral width, which is dependent on a number of factors such as modulation bandwidth and light source stability. For any given order m, the angular dispersion dβ/dλ=m sec(β)/d is tailorable by modifying the grating period d. For example, the angular dispersion may be tailored to match the controllable wavelength range of the light to correspond with the desirable angular span of the wavelength-steering. In general, the smaller the grating period d, the larger angular dispersion dβ/dλ, requiring a smaller wavelength range for a given angular span. This angular dispersion manifests as an intra-order angular separation of light of different wavelength channels for any non-zeroth order (i.e. m≠0).

FIG. 4A depicts a scenario of normal incidence (i.e. α=0) of light 306 containing multiple wavelength channels (λ_{A} . . . λ_{B}) diffracted into multiple diffraction orders m={+2, +1, 0, −1, −2}, whereas FIG. 4B depicts a scenario of non-normal incidence (i.e. α≠0) of light 408 containing a single wavelength channel (λ_{A}) diffracted into multiple diffraction orders m={0, −1}, corresponding to angularly separated light beams 410 and 412. In FIGS. 4A and 4B (and subsequent figures), the grating lines each extend along the y-axis and are spaced apart by grating period d along the x-axis, with light incident on the grating surface extending in the x-y plane. For simplicity, FIGS. 4A and 4B both illustrate each light beam as a line without indicating its beam width. A skilled person would appreciate that in practice a light beam has a certain beam width.

While a diffraction element permits tailorable angular dispersion, for any given wavelength it typically generates multiple diffraction orders, some of which are undesirable as noise. To improve the signal-to-noise ratio, it is desirable to suppress (e.g. obstruct) light of an unwanted order(s), and favour (e.g. unobstruct) light of a wanted order. FIGS. 4A and 4B illustrate, and Eq. 1 provides, that for any given incident angle α there exists an inter-order angular separation θ between successive orders. For example, for a diffraction grating used in transmission, the multiple diffraction orders typically include the m=0 order (an unwanted order) and the m=−1 order (a wanted order). Their inter-order angular separation θ_{-1, 0} is given by:

θ_{-1,0}=β(m=−1)−β(m=0)=arc sin [λ/d+sin(α)]+α (Eq. 2)

In the case where d is set (e.g. being tailored to match the controllable wavelength range with the desirable angular span), the inter-order angular separation θ is fixed for a given wavelength λ and incident angle α. The resulting spatial separation rθ (where r is the path distance since separation) may in some cases be insufficient to effectively suppress the unwanted order.

The disclosers recognise that addition of a dispersive element 414, such as a prism, to the diffractive element 400 to form a wavelength-steering element 308C increases the inter-order angular separation θ, leading to further angularly separated optical beams 410′ and 412′. As illustrated in FIG. 4C, the increased inter-order angular separation θ, hence leading to an increased spatial separation rθ, relaxes physical constraints in achieving suppression of the unwanted order in the wavelength-steering element 308C. For example, it provides additional room for placement and/or alignment of a suitable light-suppressing element 450 to suppress the unwanted order (e.g. m=0), while favouring the light path of the wanted order (e.g. m=−1). A light-suppressing element 450 may include a bandstop filter, thin-film filter and/or an optical absorber. FIG. 4C is not prepared to scale, and exaggerates the inter-order angular separation for illustrative purposes. Further, where a wavelength-steering element 308 includes multiple diffractive elements (see e.g. FIGS. 4D, 4E and 4F), light of different wavelengths λ exiting one diffractive element is incident on another diffractive element at different incident angles α_{λ}. The diffraction angle β which governs the direction of an optical beam over one dimension (hereinafter the “wavelength dimension”) therefore has an added dependence on wavelength via α_{λ}:

mλ/d=sin(α_{λ})+sin(β) (Eq. 3)

Where the diffractive element 400 is further configured to be mechanically adjusted (e.g. controllably rotated) to direct the optical beam in a dimension orthogonal to the wavelength dimension (hereinafter the “mechanical dimension”), the added dependence on wavelength via α_{λ} manifests as “bowing” or “warping” of an otherwise rectangular field of view formed by the wavelength dimension and the mechanical dimension. The addition of the dispersive element 414 reduces such bowing or warping to improve the rectangularity of the field of view. Still further, while a linear angular dispersion would facilitate an even distribution of the directed light over a linear change in wavelength, a diffraction grating exhibits nonlinear dispersion (i.e. dⁿβ/dλⁿ is non-zero for n equal to one or more integers greater than 2), leading to an uneven distribution of the directed light over a linear change in wavelength. The addition of the dispersive element 414 at least partially compensates for the nonlinear dispersion, thereby reducing or linearising the unevenness in the light distribution over a linear wavelength change. A diffractive element 400 and a dispersive element 414 may therefore be combined to form a wavelength-steering element 308C. Further arrangements combining a diffractive assembly (including one or more diffractive elements) and a dispersive assembly (including one or more dispersive elements) to form a wavelength-steering element are described below.

Examples of Spatial Profiling System

A spatial profiling system facilitated by the disclosed system may be useful in monitoring relative movements or changes in the environment. For example, in the field of autonomous vehicles (land, air, water, or space), the spatial profiling system can estimate from the vehicle's perspective a spatial profile of the traffic conditions, including the distance of any objects, such as an obstacle or a target ahead. As the vehicle moves, the spatial profile as viewed from the vehicle at another location may change and may be re-estimated. As another example, in the field of docking, the spatial profiling system can estimate from a container ship's perspective a spatial profile of the dock, such as the closeness of the container ship to particular parts of the dock, to facilitate successful docking without collision with any parts of the dock. As yet another example, in the field of line-of-sight communication, such as free-space optical or microwave communication, the spatial profiling system may be used for alignment purposes. Where the transceiver has moved or is moving, it may be continuously tracked so as to align the optical or microwave beam. As further examples, the applicable fields include, but are not limited to, industrial measurements and automation, site surveying, military, safety monitoring and surveillance, robotics and machine vision, printing, projectors, illumination, attacking and/or flooding and/or jamming other laser and IR vision systems.

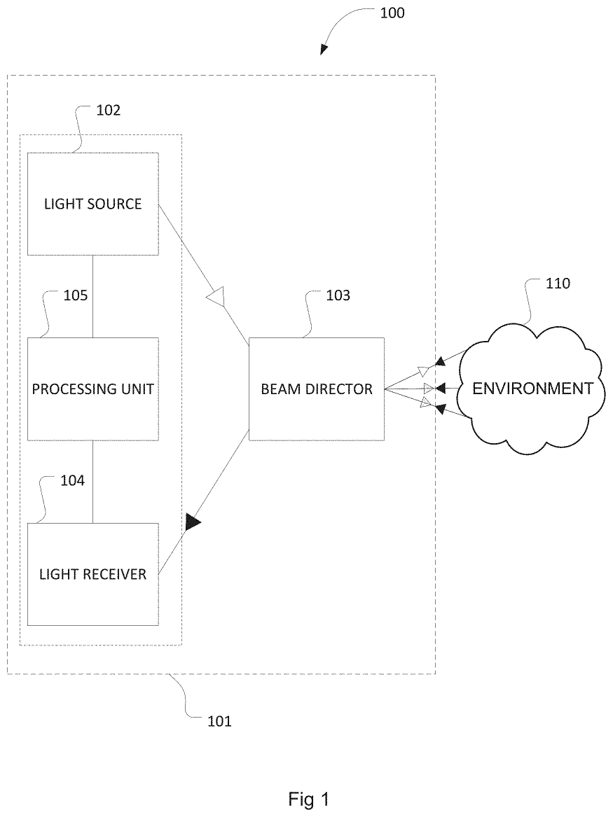

FIG. 1 illustrates an arrangement of a spatial profiling system 100. Further examples and details of a spatial profiling system are provided in PCT patent publication no. WO 2017/054036 A1, the contents of which is incorporated herein. The system 100 includes a light source 102, a beam director 103, a light detector 104 and a processing unit 105. In the arrangement of FIG. 1, light from the light source 102 is directed by the beam director 103 in a direction in one or two dimensions into an environment 110 having a spatial profile. If the outgoing light hits an object or a reflecting surface, at least part of the outgoing light may be reflected (represented in solid arrows), e.g. scattered, by the object or reflecting surface back to the beam director 103 and received at the light detector 104. The processing unit 105 is operatively coupled to the light source 102 for controlling its operations. The processing unit 105 is also operatively coupled to the light detector 104 for determining the distance to the reflecting surface, by determining the round-trip time for the reflected light to return to the beam director 103.

In one variant, the light source 102, the beam director 103, the light detector 104 and the processing unit 105 are substantially collocated. For instance, in an autonomous vehicle application, the collocation allows these components to be compactly packaged within the confines of the vehicle or in a single housing. In another variant (not shown), the light source 102, the light detector 104 and the processing unit 105 are substantially collocated within a “central” unit, whereas the beam director 103 is remote from the central unit 101. In this variant, the central unit 101 is optically coupled to the remote beam director 103 via one or more optical fibres. This example allows the remote beam director 103, which may include only passive components (such as passive cross-dispersive optics), to be placed in more harsh environment, because it is less susceptible to external impairments such as heat, moisture, corrosion or physical damage. In yet another variant (not shown), a spatial profiling system may include a single central unit and multiple beam directors. Each of the multiple beam directors may be optically coupled to the central unit via respective optical fibres. The multiple beam directors may be placed at different locations and/or orientated with different fields of view (e.g. at the four corners of a vehicle). Unless specified otherwise, the description hereinafter refers to the collocation variant, but a skilled person would appreciate that with minor modifications the description hereinafter is also applicable to other variants.

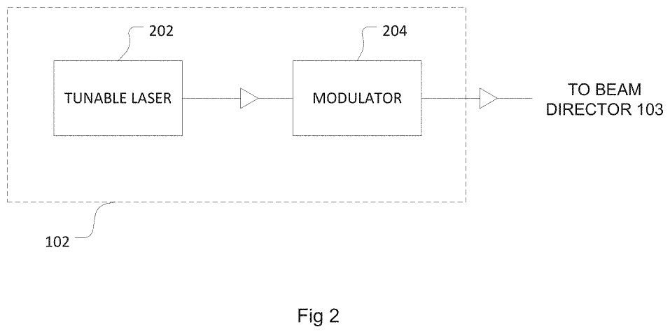

In one arrangement, the light source 102 is configured to provide the outgoing light having a time-varying intensity profile at a selected one of multiple wavelength channels (each represented by its respective centre wavelength λ₁, λ₂, . . . λ_{N}). FIG. 2 illustrates an example of one such arrangement of the light source 102. In this example, the light source 102 may include a wavelength-tunable light source, such as a wavelength-tunable laser diode, providing light of a tunable wavelength based on one or more electrical currents (e.g. the injection current into the into one of more wavelength tuning elements in the laser cavity) applied to the laser diode. In another example (not shown), the light source 102 may include a broadband light source and a tunable spectral filter to provide substantially continuous-wave (CW) light intensity at the selected wavelength.

In the example of FIG. 2, the light source 102 may include a modulator 204 for imparting a time-varying intensity profile on the outgoing light. In one example, the modulator 204 is a semiconductor optical amplifier (SOA) or a Mach Zehnder modulator integrated on the laser diode. The electrical current applied to the SOA may be varied over time to vary the amplification of the CW light produced by the laser over time, which in turn provide outgoing light with a time-varying intensity profile. In another example, the modulator 204 is an external modulator (such as a Mach Zehnder modulator or an external SOA modulator) to the laser diode. In yet another example, instead of including an integrated or external modulator, the light source 102 includes a laser having a gain medium into which an excitation electrical current is controllably injected for imparting a time-varying intensity profile on the outgoing light.

In another arrangement (not shown), instead of having a wavelength-tunable laser 202, the light source 206 includes a broadband laser followed by a wavelength-tunable filter. In yet another arrangement (not shown), the light source 206 includes multiple laser diodes, each wavelength-tunable over a respective range and whose respective outputs are combined to form a single output. The respective outputs may be combined using a wavelength combiner, such as an optical splitter or an AWG.

The light source 102 is configured to provide light at selected one or more of multiple wavelength channels. In one arrangement, the light source 102 provides a single selected wavelength channel at a time, such as a wavelength-tunable laser. In this arrangement, the described system 100 is capable of steering light in a particular direction based on one selected wavelength channel at a time. In another arrangement, the light source 102 provides a single or multiple selected wavelength channels, such as a broadband source followed by a tunable filter, the tunable pass band of which includes the single or multiple selected wavelength channels. Where one selected wavelength channel is used at a time, the light detector 104 may include an avalanche photodiode (APD) that detects any wavelength within the range of the multiple wavelength channels. Where multiple selected wavelength channels are used at a time, the light detector 104 may include a wavelength-sensitive detector system, such as using multiple APDs each dedicated to a specific wavelength channels, or using a single APD for multiple wavelength channels, each channel being distinguishably detectable based on their time-varying attribute (e.g. based on a different sinusoidal modulation such as a modulation frequency of 21 MHz, 22 MHz and 23 MHz . . . corresponding, respectively, to 1550.01, 1550.02 and 1550.03 nm . . . channels). The description hereinafter relates to light direction by providing a single selected wavelength channel at a time, but a skilled person would appreciate that, with minor modifications, the description is also applicable to light direction by providing multiple selected wavelength channels at a time.

The operation of the light source 102, such as both the wavelength-tunable laser 202 (e.g. its wavelength) and the modulator 204 (e.g. the modulating waveform), may be controlled by the processing unit 105.

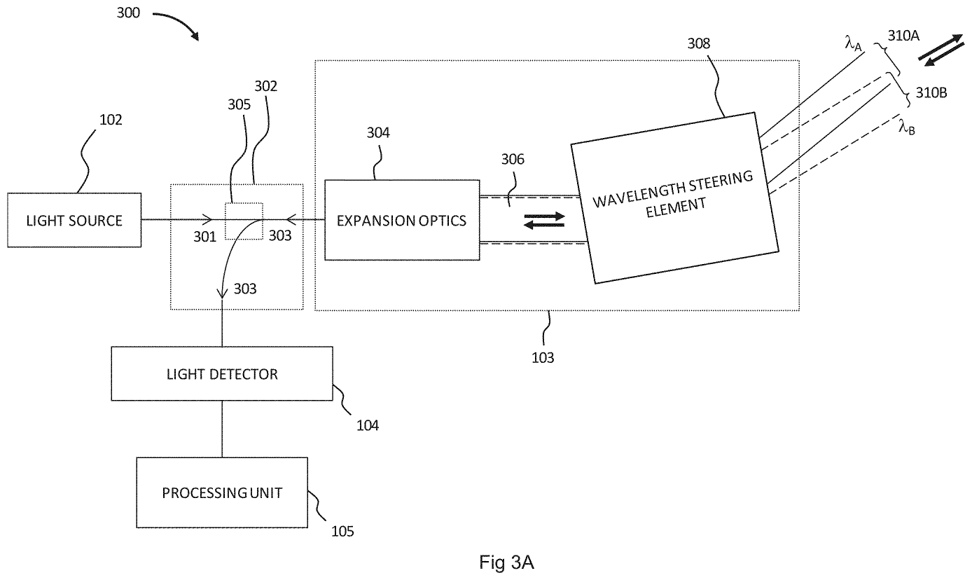

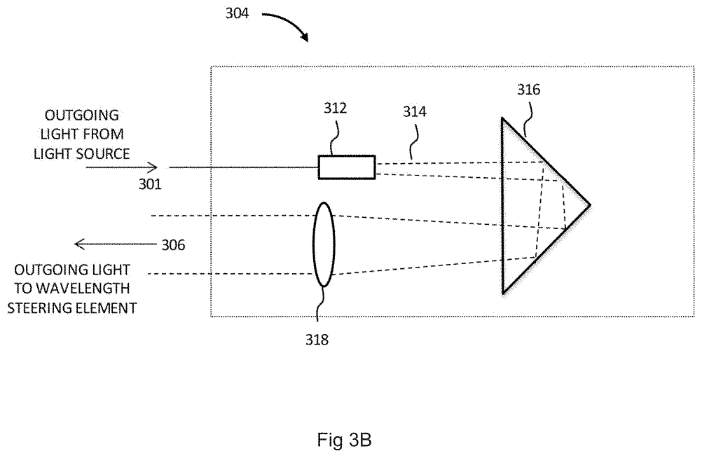

FIG. 3A illustrates an example 300 of the spatial profiling system in FIG. 1. In this example, the system 300 includes a light transport assembly 302 configured to transport the outgoing light 301 from the light source 102 to the beam director 103 and transport the reflected light 303 from the beam director 103 to the light detector 104. The light transport assembly 302 includes optical waveguides such as optical fibres or optical circuits (e.g. photonic integrated circuits) in the form of 2D or 3D waveguides. The outgoing light from the light source 102 is provided to the beam director 103 for directing into the environment. In some embodiments, any reflected light collected by the beam director 103 may additionally be directed to the light detector 104. In one arrangement, for light mixing detection, light from the light source 102 is also provided to the light detector 104 for optical processing purposes via a direct light path (not shown) from the light source 102 to the light detector 104. For example, the light from the light source 102 may first enter a sampler (e.g. a 90/10 guided-optic coupler), where a majority portion (e.g. 90%) of the light is provided to the beam director 103 and the remaining sample portion (e.g. 10%) of the light is provided to the light detector 104 via the direct path. In another example, the light from the light source 102 may first enter an input port of an optical switch and exit from one of two output ports, where one output port directs the light to the beam director 103 and the other output port re-directs the light to the light detector 104 at a time determined by the processing unit 105.

The light transport assembly 302 includes a three-port element 305 for coupling outgoing light received from a first port to a second port and coupling received from the second port to a third port. The three-port element may include an optical circulator or a 2×2 coupler (where a fourth port is not used). In one arrangement, the light transport assembly 302 includes an outbound guided-optic route between the light source 102 and the beam director 103 for carrying the outgoing light 301 at the first and second selected wavelength channels and an inbound guided-optic route 303 between the beam director 102 and the light detector 104 for carrying the reflected light 303 at the first and second selected wavelength channels (either at the same time or at different times). The guided-optic routes may each be one of a fibre-optic route and an optical circuit route.

Beam Director

In one arrangement, as illustrated in FIG. 3A, the beam director 103 includes beam expansion optics 304. As illustrated in FIG. 3B, an example of the beam expansion optics 304 includes a pigtailed collimator 312, such as a graded-index (GRIN) lens, to provide the outgoing light 301 from a wave-guided form into free-space form 314. The light in free-space form 314 continues to diverge in accordance with spatial diffraction optics. Where the light in free-space form 314 exhibits Gaussian intensity distribution, the light follows Gaussian diffractive optics. The beam expansion optics 304 further includes a retroreflector assembly 316 to receive and retro-reflect the light in free-space form 314 towards a focussing element 318. The retroreflector assembly 316 is adjustably placed based on the focal length of the focussing element 318 in order to focus the diverging beam into an expanded collimated beam 306 towards the wavelength steering element 308. Use of the retroreflector assembly 316 reduces the footprint by folding an optical path while relaxing the optical alignment requirements. Further, use of the retroreflector assembly 316 provides angular tolerance to slight misalignment as a retroreflector is designed to parallelise an incoming optical beam with an outgoing optical beam. Referring back to FIG. 3A, the solid lines and the dashed lines represent expanded beams in different selected wavelength channels, and are illustrated to be slightly offset for illustrative purposes. In practice they may or may not overlap substantially or entirely in space. FIGS. 4D to 4F depicting solid and dashed lines are represented in a similar manner.

The beam director 103 further includes a wavelength-steering element 308 providing angular separation of light based on its wavelength. The wavelength-steering element 308 is configured to direct the expanded beam 306 into at least a first direction 310A and a second direction 310B along the first dimension, depending on the wavelength. The difference in angle between the directions 310A and 310B is the intra-order angular separation of light of the respective different wavelength channels. While the wavelength-steering element 308 is schematically illustrated in the form of a block for simplicity, its actual form may differ and include at least a diffractive element and at least a dispersive element, such as that illustrated in FIG. 4C. Examples of the wavelength-steering element 308 include one or more diffraction elements and one or more dispersive elements, are illustrated and described in relation to FIGS. 4C to 4F. The first direction 310A corresponds to the outgoing light at a first selected wavelength channel λ_{A}. The second direction 310B corresponds to the outgoing light at a second selected wavelength channel λ_{B} of the same order. Unlike FIG. 4C which illustrates both the optical beam 410′ of the suppressed order and the optical beam 412′ of the favoured order, for simplicity, FIGS. 4D to 4F illustrate only the favoured order (e.g. m=−1) as optical beams 412A and 412B, with the remaining orders (e.g. the m=0 order) and the light suppressing element 450 implicitly represented but not shown.

FIG. 4D illustrates an example of a wavelength-steering element 308D including multiple diffraction gratings 400A, 400B and 400C. While this example illustrates an example with three diffraction gratings, a skilled person would appreciate that more or fewer diffraction gratings may be used. Each additional diffraction grating may provide additional diffraction, hence greater angular separation of the differently directed beams. The use of separate diffraction gratings may also allow a greater number of degrees of freedom in designing the wavelength-steering element 308D (e.g. by relaxing anti-reflection coating requirements by selecting angles towards normal incidence rather than grazing incidence). However, each additional diffraction grating may also increase attenuation (e.g. through a finite diffraction efficiency of the gratings). Each diffraction grating is configured to produce at least one diffraction order including the favoured order (e.g. the m=−1 order) that is formed by outgoing beams directed to slightly different angles depending on the wavelength. The diffraction gratings 400A, 400B and 400C are configured to direct the expanded beam 406 into at least a first direction 412A and a second direction 412B along a first dimension, depending on the wavelength. The first direction 412A corresponds to the outgoing light at a first selected wavelength channel λ_{A}. The second direction 412B corresponds to the outgoing light at a second selected wavelength channel λ_{B}. FIG. 4D illustrates that each diffraction grating produces one diffraction order but in practice each may produce one or more additional orders. At each diffraction grating, the beam is incrementally angularly dispersed. The use of multiple diffraction gratings increases the angular separation compared to an arrangement with, e.g. a single diffraction grating. Further, the multiple diffraction gratings are arranged to turn the light beam in the unidirectional beam path (e.g. clockwise as illustrated in FIG. 4D through gratings 400A, 400B and then 400C or anti-clockwise). The inclusion of a dispersive element, such as prism 414 or a silicon wedge, increases the inter-order angular separation (not shown), hence increasing the spatial separation to allow more room for placement and/or alignment of a light-suppressing assembly, which may include one or more light-suppressing elements 450. A light-suppressing element may include a bandstop filter to suppress the unwanted light and/or an optical absorber positioned to absorb the unwanted light. The bandstop filter includes an angle-dependent filter to inhibit the m=0 order light, for example, from exiting the wavelength-steering element 308. FIG. 4H illustrates an example of the transmissivity of the angle-dependent filter over wavelength range of 1520-1580 nm at different incident angles of 40, 50, 60, 65, 70 and 75 degrees, relative to the incident surface of the filter. In this example, the light incident at around 65 degrees or above (e.g. at 75 degree) on the filter is subject to relatively flat transmission spectral filter characteristics. A flat transmission spectral filter allows light of all relevant wavelengths to substantially transmit. In comparison, the light incident at below 50 degrees (e.g. at 40 degree) on the filter is subject to long edge pass spectral filter characteristics. A long edge pass spectral filter gradually suppresses light below a certain wavelength. In cases where the inter-order angular separation is increased by the dispersive element to 35 degrees or above, the angle-dependent filter may be angled, or otherwise placed and/or aligned, to suppress light of the unwanted order and favour light of the wanted order. The suppressed light may be substantially reflected or scattered instead of being substantially transmitted. Where the optical absorber is not used in combination with the bandstop filter, the optical absorber may be positioned in the directed path of the unwanted diffracted order. Where the optical absorber is used in combination with the bandstop filter, the optical absorber may be positioned along the light path of the reflected or scattered light by the filter to absorb the unwanted light. The optical absorber may include an angle dependant absorbing or reflecting materials.

FIGS. 4E and 4F illustrate other examples of a wavelength-steering element (308E and 308F). Each of the wavelength-steering elements in these other examples includes multiple diffraction gratings and multiple dispersive elements. The wavelength-steering element 308E includes three diffraction gratings 400A, 400B and 400C and two dispersive elements 414A and 414B. The wavelength-steering element 308F includes two diffraction gratings 412A and 412B and two dispersive elements 414A and 414B. In these arrangements, the one or multiple dispersive elements intersperse with the one or more multiple diffractive elements for space-saving.

The unidirectional beam path facilitates folding of the optical path to reduce the size of the wavelength-steering element 308 and hence the overall system footprint. This path folding is in addition to and in conjunction with the path-folding by the retroreflector 316. The cooperative path-folding by the retroreflector 316 and the wavelength-steering element 308D, 308E or 308F provides space-saving advantages. For example, as illustrated in FIG. 4G, the combination of the retroreflector 316 and the wavelength-steering element 308F facilitates an S-shaped optical path such that the input and output light through the beam director 103 remain on opposite sides.

In the arrangements of FIGS. 4C to 4F, the initial inter-order angular separation (e.g. α+β in FIG. 4C) between the m=0 and m=−1 orders may be approximately 15° to 30°. Depending on the orientation and the apex angle of the dispersive element(s), it has been found that the inter-order angular separation (e.g. between optical beam 410′ and 412′ in FIG. 4C) may be increased to up to around 35°. This increased angular separation leads to an increased spatial separation to allow for more room for placement and/or alignment of the light-suppressing element 450. Further, the orientation and the apex angle of the dispersive element(s) may be selected to improve the rectangularity of the field of view formed by the wavelength dimension and the mechanical dimension. The refraction provided by the dispersive element(s) reduces the cross-coupling effects between the wavelength dimension (by selecting the wavelength channel of the light source) and the mechanical dimension (by mechanical adjustment, such as rotation, of the diffractive element) to rectangularise the field of view. For example, it has been observed that the refraction reduces the cross-coupling effect from the mechanical adjustment on the wavelength dimension by approximately 0.4 to 0.5 degree per nm.

Two-Dimensional and Three-Dimensional Mapping

The disclosure hereinbefore relates to facilitating estimation of a spatial profile by directing light over a first dimension (such as the vertical direction) based on wavelength. The present disclosure also envisages extending to directing light over a second dimension, substantially perpendicular to the first dimension (such as the horizontal direction), based on mechanical adjustments of optical components. In one arrangement, the wavelength-steering element 308 illustrated in the example of FIG. 3, which directs light in a first dimension based on its wavelength, may include an angularly adjustable reflective element to controllably reflect light over a second dimension perpendicular to the first dimension. The angular adjustment may be controlled by an optical positioning system. In one example, the optical positioning system is a microelectromechanical system (MEMS). The MEMS include an array of individually actuatable mirrors to reflect light. In another example, the optical positioning system is galvanometer scanning system. Compared to some other examples, the galvanometer scanning system is relatively compact. In yet another example, the optical positioning system is a polygonal scanning system. The polygonal scanning system includes a rotatable refractive element, such as a triangular or rectangular prism, or a rotatable reflective element such as a mirror, which upon rotation about an axis is configured to direct light over the second dimension at a scanning rate based on its rotational speed. In one form, a system for facilitating estimation of a spatial profile may be configured to direct light into two dimensions by controlling the wavelength channel for one dimension and adjusting the angle of the angularly adjustable reflective element for the other dimension. The processing unit 105 may be operatively coupled to both the light source 102 for wavelength control and the angularly adjustable reflective element for angular control.

In another arrangement, any one or more of the diffraction gratings 400A, 400B and 400C (hereinafter 400x) in any of FIGS. 4D, 4E and 4F may be controllably tilted about a tilting axis to direct the outgoing light in the second dimension perpendicular to the first dimension. The controllable tilting may be achieved by continuous rotation of the diffraction grating 400x. The tilting axis is substantially parallel to grating normal 402. Where only one of the multiple diffraction gratings is controllably tilted, the diffraction grating to be controllably tilted may be the diffraction grating which light last passes before being directed into the environment 110 (e.g. 400C in FIGS. 4D and 4E and 400B in FIG. 4F). A skilled person would appreciate that the tilting axis may not necessarily pass through the centre of the diffraction grating 400x. For example, the tilting axis may be offset from the centre of the diffraction grating 400x. Further, the tilting axis may not necessarily pass through the diffraction grating 400x.

An adjustment of the tiltable angle of the diffraction grating 400x causes a corresponding change in the output beam's direction along the second dimension. The sensitivity (e.g. based on a comparison between a range of tiltable angles of the diffraction grating 400x compared to a range of the directions of the output beam) may range between approximately 0.5 to 2 degrees of output beam direction over the second dimension per degree of grating tilt. In one instance, beam direction over 80 degrees can be achieved by tilting a single diffraction grating by 40 degrees (i.e. a sensitivity of 2.0 degrees). In another instance, beam direction over 120 degrees can be achieved by tilting a single diffraction grating by 180 degrees (i.e. a sensitivity of 0.67 degrees). While a change in the grating tilt angle predominantly results in beam direction in the second dimension, it may also manifest in a, usually comparatively smaller, change in the beam direction over the first dimension (i.e. the wavelength dimension). This manifestation may in one arrangement advantageously extend the range of the beam direction along the first dimension. For example, an adjustment of the tiltable angle of the diffraction grating 400x over 140 degrees causes the output beam to be directed over 120 degrees along the second dimension, but over 5 degrees along the first dimension out of 30 degrees total beam direction over the first dimension.

As mentioned previously, the addition of a dispersive element, for example the dispersive element 414 shown in FIG. 4C, after a tiltable diffraction grating may reduce the effects of bowing or warping, to improve the rectangularity of the field of view formed by the wavelength dimension and the mechanical dimension. Such “bowing” or “warping” may be further reduced or controlled by adopting a particular arrangement of the dispersive element 414.

In some embodiments, the orientation of the dispersive element 414 is selected to improve, optimise or achieve a particular rectangularity of the field of view. The selection may be performed through simulation, for example by selecting a measure of rectangularity of the field of view as a goal function and running an optimisation algorithm to find an optimal or otherwise suitable orientation. For example, an optimisation variable may be an angle of orientation about an axis perpendicular to the grating normal 402, or at least having a substantial component perpendicular to the grating normal 402. Continuing with the example shown in FIG. 4C, the dispersive element 414 may be rotated as indicated by the arrows marked A about an axis marked B that extends into and out of the page. Although the axis B is shown to intersect the grating normal 402 and a mid-point of the prism, this positioning is not essential.

A dispersive element with an orientation selected to improve, optimise or achieve a particular rectangularity of the field of view may or may not be used in combination with a light-supressing element. When a light suppressing element is used, it may be used following the dispersive element, for example as shown in FIG. 4C. Alternatively, the light suppressing element may be located between the tilting diffractive element and the dispersive element, particularly if the inter-order angular separation is sufficient out of the diffractive element to enable selective suppression. In some embodiments there are a plurality of dispersive elements along the light path, for example as shown in FIGS. 4E and 4F which both include a plurality of stages of diffraction and a plurality of stages of dispersion. Each stage of dispersion may use one or more dispersive elements with an orientation selected to improve, optimise or achieve a particular rectangularity of the field of view. The use and positioning of a light suppressing element may be selected for each stage.

In some embodiments, one or more further properties of the dispersive element 414 are selected to improve, optimise or achieve a particular rectangularity of the field of view, in addition to selecting the orientation. These further properties may include one or more of the internal angles of the dispersive element 414 and the geometric shape of the dispersive element. As with the orientation, these variables may be selected through simulation, for example by selecting a measure of rectangularity of the field of view as a goal function and running an optimisation algorithm to find an optimal or otherwise suitable orientation together with the one or more further properties selected for optimisation.

Referring to the embodiments of FIGS. 4D, 4E and 4F, any one or more of the diffraction gratings 400x may be controllably tilted. One of more of the tilting diffraction gratings 400x may be followed by a tiltable dispersive element, which may be one or more of the dispersive elements 414, 414A, 414B or an additional tiltable dispersive element inserted into the system.

As illustrated in FIG. 4I, a configuration 3081-1 with one diffraction grating 4001, followed by one dispersive element 4141-1 was simulated. Another configuration of 3081-2 was also simulated, the configuration including the same diffraction grating 4001 and another dispersive element 4141-2 positioned after the diffraction grating 4001. Both configurations 3081-1 and 3081-2 include a suitable light-suppressing element 450 to suppress the unwanted order, respectively. Both were simulated to receive as an input to the diffraction grating 4001 a range of wavelengths of light, distributed across a first dimension (i.e. a wavelength dimension). The diffraction grating 4001 in both configurations 3081-1 and 3081-2 is controllably tilted about a tilting axis, in particular by continuous rotation, to direct the outgoing light in the second dimension (i.e. mechanical dimension) perpendicular to the first dimension (i.e. wavelength dimension).

The dispersive element 4141-2 has an orientation and geometry optimised in relation to rectangularity of the field of view, whereas the dispersive element 4141-1 was selected and oriented to increases the inter-order angular separation without specific regard to optimising rectangularity of the field of view.

Results of the field of view 405A and 405B with different wavelength channels (λ_{A}, λ_{B}, and λ_{C}) are illustrated in FIG. 4I below the corresponding configuration. It can be observed that the configuration 3081-2 with optimised tiltable angle and geometry of the dispersive element provides a “bowing” angle of 8 degrees, which is less than 15 degrees provided by the configuration 3081-1. According to the simulation results, the maximum horizontal field of view is increased from 90 degrees to 120 degrees whilst signal duty cycle is improved from 55% to 78%.

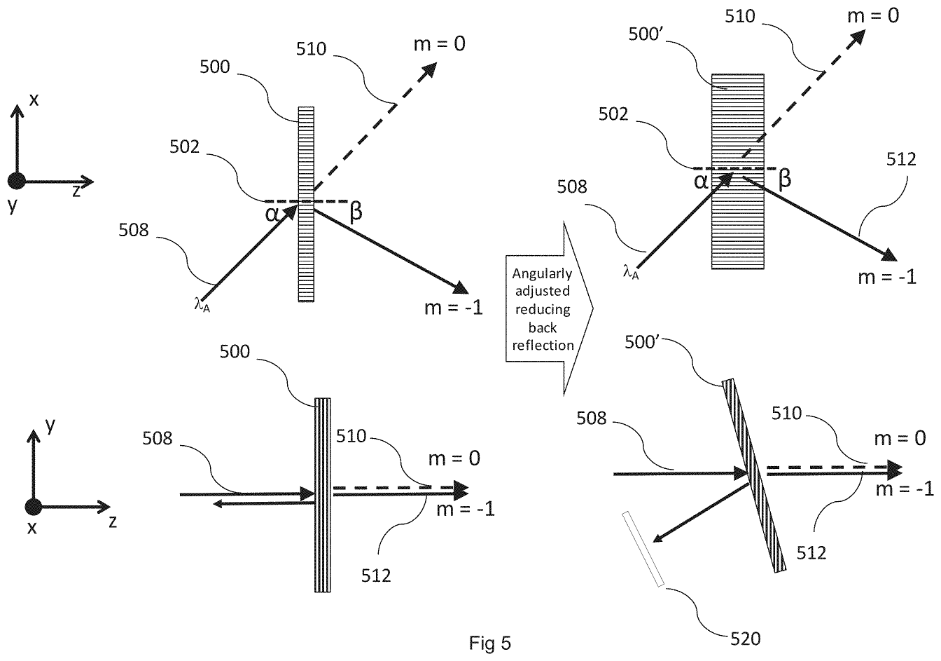

FIG. 5 illustrates an arrangement of a diffractive element 500 of a wavelength-steering element. Like components to those in FIG. 4B are similarly labeled. The diffractive element 500 represents any of the diffractive elements illustrated FIGS. 3 and 4. With the diffractive element 500 being a transmission diffraction grating, any back reflection may cause noise in the light receiver 104 or instability in the light source 102. To reduce the back reflection, the diffractive element 500 may be angularly adjusted about an axis parallel to lines of the transmission diffraction grating (i.e. parallel to the x-axis in FIG. 5). The angular adjustment causes light originating from the light source 102 to be received at the diffractive element 500 at a non-normal angle of incidence to reduce back reflection. For example, it is expected that an approximately one to two degrees of angular adjustment (leading to an approximately two to four degrees of beam diversion) is sufficient to avoid back reflection. The optimum angular adjustment depends at least on the positions of the optical elements in the light receiver 104. An optical absorber 520 may be positioned along the path of this back reflection to avoid subsequent reflection off other nearby components.

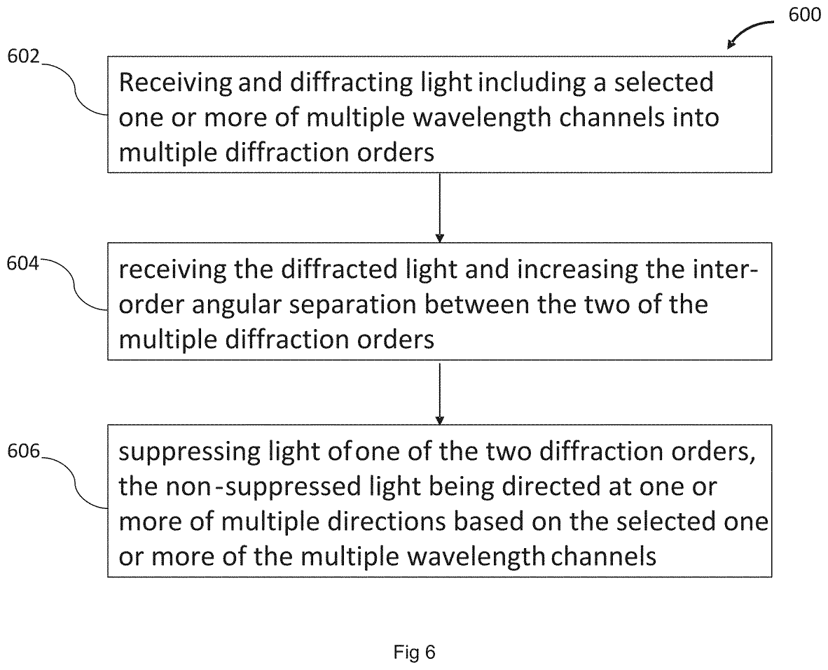

Based on the foregoing, as illustrated in FIG. 6, the present disclosure provides a method 600 for directing light into multiple directions, the method including the step 602 of receiving and diffracting light including a selected one or more of multiple wavelength channels into multiple diffraction orders, two of the multiple diffraction orders being angularly separated by an inter-order angular separation, the step 604 of receiving the diffracted light and increasing the inter-order angular separation between the two of the multiple diffraction orders, at least one of the two of the multiple diffraction orders exhibiting an intra-order angular separation of the multiple wavelength channels, and the step 606 of suppressing light of one of the two diffraction orders, the non-suppressed light being directed at one or more of multiple directions based on the selected one or more of the multiple wavelength channels.

Now that arrangements of the present disclosure are described, it should be apparent to the skilled person in the art that at least one of the described arrangements have the following advantages:
The increased inter-order angular separation leads to an increased spatial separation to relax spatial requirements (e.g. allowing for more room for placement and alignment of light suppressing element) to suppress unwanted diffraction orders.
The effects of nonlinear dispersion on warping of bowing of the field of view are reduced.
Increased field of view.
Improved signal duty cycle.
An angularly adjustment diffractive element of a wavelength-steering element reduces back reflection to the light receiver and/or light source.
The path-folding of the retroreflector together with the path-folding of the multiple diffractive elements achieves footprint reduction.

It will be understood that the invention disclosed and defined in this specification extends to all alternative combinations of two or more of the individual features mentioned or evident from the text or drawings. All of these different combinations constitute various alternative aspects of the invention.

Reference to any prior art in the specification is not, and should not be taken as, an acknowledgment or any form of suggestion that this prior art forms part of the common general knowledge in any jurisdiction or that this prior art could reasonably be expected to be understood, regarded as relevant and/or combined with other pieces of prior art by a person skilled in the art.

As used herein, except where the context requires otherwise, the term “comprise” and variations of the term, such as “comprising”, “comprises” and “comprised”, are not intended to exclude further additives, components, integers or steps.

1.-17. (canceled)

18. An optical system for directing light into multiple directions, the optical system including:
a diffractive assembly configured to receive light including a selected one or more of multiple wavelength channels, the diffractive assembly including at least one diffractive element configured to diffract the received light into multiple directions based on the selected one or more of multiple wavelength channels, wherein the multiple directions are associated with a first dimension, wherein the diffractive assembly is further configured to direct the light over a second dimension orthogonal to the first dimension by mechanical adjustment of a diffractive element in the diffractive assembly; and
a dispersive assembly arranged to receive the diffracted light and increase rectangularity of a field of view formed by the first dimension and the second dimension.

19. The optical system of claim 18 configured to further increase the rectangularity of the field of view by mechanical adjustment of the dispersive assembly.

20. The optical system of claim 18 wherein the dispersive assembly is oriented relative to the diffractive assembly in an orientation selected to provide at least part of the increased rectangularity of field of view.

21. A method for directing light into multiple directions, the method including:
at a diffractive assembly comprising at least one diffracting element:
receiving and diffracting light including a selected one or more of multiple wavelength channels into multiple directions based on the selected one or more of multiple wavelength channels, wherein the multiple directions are associated with a first dimension; and
directing the light over a second dimension orthogonal to the first dimension by mechanical adjustment of at least one said diffracting elements; and
at a dispersive assembly comprising at least one dispersive element:
increasing rectangularity of a field of view formed over the first dimension and the second dimension.

22. The method of claim 21 wherein increasing rectangularity of the field of view is further achieved by mechanical adjustment of the dispersive assembly and/or geometry adjustment of the dispersive assembly.

23. The method of claim 21, wherein the at least one dispersive element has a fixed position and orientation and wherein increasing rectangularity of the field of view is further achieved by optimising the orientation of the at least one dispersive element.

24. The method of claim 23, wherein increasing rectangularity of the field of view is further achieved by optimising at least one of one or more internal angles and a geometric shape of the at least one dispersive element.

25. The method of claim 21, further including, at the dispersive assembly, at least partially compensating for nonlinear dispersion with respect to the multiple wavelength channels.

26. The method of claim 21, wherein the mechanical adjustment of the at least one diffractive element comprises continuation rotation of the diffractive element.

27. The method of claim 21, wherein the mechanical adjustment of the at least one diffractive element comprises rotational movement about an axis substantially parallel to a normal of a grating of the diffractive element.

28. The method of claim 21, wherein increasing rectangularity of the field of view comprises refracting light to reduce cross-coupling effects from the mechanical adjustment on the wavelength dimension.

29. The optical system of claim 19, configured to further increase the rectangularity of the field of view by geometry adjustment of the dispersive assembly.

30. The optical system of claim 18, configured to further increase the rectangularity of the field of view by geometry adjustment of the dispersive assembly.

31. The optical system of claim 18, wherein the dispersive assembly is further arranged to at least partially compensate for nonlinear dispersion with respect to the multiple wavelength channels.

32. The optical system of claim 18, wherein the mechanical adjustment of the diffractive element in the diffractive assembly comprises continuous rotation of the diffractive element.

33. The optical system of claim 18, wherein the mechanical adjustment of the diffractive element in the diffractive assembly comprises rotational movement about an axis substantially parallel to a normal of a grating of the diffractive element.

34. The optical system of claim 18, wherein the dispersive assembly is configured to increase an inter-order angular separation between two of multiple diffraction orders of the diffractive assembly and wherein the optical system further includes a light-suppressing assembly configured to suppress the light of one of the two diffraction orders.

35. The optical system of claim 18, wherein the dispersive assembly reduces cross-coupling effects from the mechanical adjustment on the wavelength dimension.

36. A spatial profiling system including:
a light source configured to selectively provide outgoing light at one or more of multiple wavelength channels;
a beam director comprising:
at least one diffractive element configured to diffract the multiple wavelength channels into a first set of multiple different directions, wherein the first set of multiple different directions are associated with a first dimension,
at least one diffractive element configured to mechanically tilt to thereby direct the multiple wavelength channels into a second set of multiple different directions, wherein the first and second sets of multiple directions form a generally rectangular field of view; and
a dispersive assembly arranged to receive the diffracted light and increase rectangularity of the field of view formed by the first and second sets of multiple directions;
a light receiver configured to receive at least part of the outgoing light reflected by an environment within the field of view; and
a processing unit configured to determine at least one characteristic associated with the reflected light for estimation of a spatial profile of the environment.

37. The spatial profiling system of claim 36, further comprising a light-suppressing assembly configured to receive at least two diffraction orders in the diffracted and dispersed light and suppress the light of at least one of the two diffraction orders.
